(19) United States
(12) Patent Application Publication
(10) Pub. No.: US 2014/0152596 A1
(43) Pub. Date: Jun. 5, 2014

(54) MOBILE COMMUNICATION DEVICE

(71) Applicant: Pantech Co., Ltd., Seoul (KR)

(72) Inventor: Sung Jun PARK, Seoul (KR)

(73) Assignee: Pantech Co., Ltd., Seoul (KR)

(21) Appl. No.: 14/084,094

(22) Filed: Nov. 19, 2013

(30) Foreign Application Priority Data
Nov. 30, 2012 (KR) 10-2012-0137636

(51) Int. Cl. G06F 3/041

(52) U.S. Cl. CPC G06F 3/041
USPC 345/173

(57) ABSTRACT

A mobile device includes a window to receive a touch input of a user, a housing on which the window is mounted, and a display module including a display part configured to display an image through the window and a driving part configured to drive the display part. The window is disposed above the display module and the physical key is disposed above the driving part.

### CROSS-REFERENCE TO RELATED APPLICATION

This application claims priority from and the benefit under 35 U.S.C. §119(a) of a Korean Patent Application No. 10-2012-0137636, filed on Nov. 30, 2012, which is hereby incorporated by reference for all purposes as if fully set forth herein.

### BACKGROUND

1. Field

The present disclosure relates to a mobile communication device, and more particularly, to a mobile communication device that includes a switch and a display screen.

2. Discussion of the Background

FIG. 1 and FIG. 2 show a general mobile communication device 1. Referring to FIG. 1 and FIG. 2, the mobile communication device 1 may be classified into a display area having a length X in which an image or a screen is displayed and a margin area having a length Y in which an image is not displayed. The size of a device may be determined depending on the lengths X and Y of the display area and the margin area, respectively.

Recently, the length X of the display area for mobile communication devices is increasing, since demands for a large and full screen for mobile communication devices have been increased. However, since the length Y of the margin area increases as the length X of the display area increases, the entire size of the mobile communication device increases. Further, without decreasing the length Y of the margin area, the entire size of the mobile communication device increases as the length X of the display area increases.

In the margin area, particularly in a lower end portion of the margin area, a driving device of a display module is disposed. Therefore, the margin area is longer at the lower end portion of the mobile communication device in comparison to the upper end portion and side portions of the mobile communication device.

Further, in order to design a touch input unit and a button input unit in a single device to meet various needs of users, a button input unit is generally provided in the lower end portion of the device.

In FIG. 1 and FIG. 2, a length A represents a distance from the display area to the button input unit 30. The length A allows a display module to be disposed in the device and generally has a length of at least 5 to 6 mm, regardless of functions and designs of the device. More specifically, the display module includes an inner portion beneath the length A. The inner portion may include a driving module, a control module, and the like for the display panel corresponding to the display area having the length X. Thus, the button input unit 30 is generally disposed such that the edge of the display area having the length X and the button input unit 30 are separated apart from each other with the distance of the length A. Referring to FIG. 2, the mobile communication device includes a display module 20, a window unit 10, and a button input unit 30. The display module 20 includes a display part 21, a driving part 25 and a base part 23 on which the display part 20 and the driving part 25 are disposed. In addition, the button input unit 30 is formed at one end of the window unit 10, and a black printing 13 may be formed at one end of the window unit 10 to hide parts beneath the inactive area in which an image is not displayed. The button input unit 30 includes a button part 31, an input part 33, and a switch 35 contacting the input part 33. The input part 33 and the switch 35 are configured to be connected to each other to electrically connect to a main circuit unit 39 through a connection unit 37. In this configuration, the button input unit 30 is spaced apart from the display area by the length A.

Therefore, the length A is generally formed with a certain length, which is increases the length of the lower end portion of the margin area of the mobile communication device. Moreover, due to the increased length of the lower end portion, there are many limitations in terms of user's sight and mobile communication device design, and the distance between the button input unit 30 and the display area is not reduced due to the length A.

### SUMMARY

Exemplary embodiments of the present invention provide a mobile communication device. The mobile communication device may include a larger size of a display area without increasing the total size of the surface area in which the display area is included. A home switch or a home button in proximity to the display area may be disposed such that the distance between an edge of the display area and the switch is reduced, thereby providing a large and full screen while maintaining a slim and small device size.

Additional features of the invention will be set forth in the description which follows, and in part will be apparent from the description, or may be learned by practice of the invention.

Exemplary embodiments of the present invention provide a mobile device, including: a window to receive a touch input of a user; a housing on which the window is mounted; and a display module including a display part configured to display an image through the window and a driving part configured to drive the display part. The window is disposed above the display module and the physical key is disposed above the driving part.

Exemplary embodiments of the present invention provide a mobile device, including: a window to receive a touch input of a user, the window including an active area and an inactive area; a housing on which the window is mounted; and a display module including a display part configured to display an image through the active area of the window and a driving part configured to drive the display part. The window is disposed above the display module and at least part of the physical key is disposed above the driving part.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a partially exploded plan view showing a general mobile communication device according to the related art.

FIG. 2 is a cross-sectional view showing the mobile communication device of FIG. 1 according to the related art.

FIG. 3 is a cross-sectional view showing a mobile communication device according to an exemplary embodiment of the present invention.

FIG. 4 is a perspective view showing a dome-type switch according to an exemplary embodiment of the present invention.

FIG. 5 is a cross-sectional view showing a mobile communication device according to an exemplary embodiment of the present invention.

FIG. 6A is a cross-sectional view showing a mobile communication device according to an exemplary embodiment of the present invention.

FIG. 6B is a transparent plan view showing the mobile communication device of FIG. 6A according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

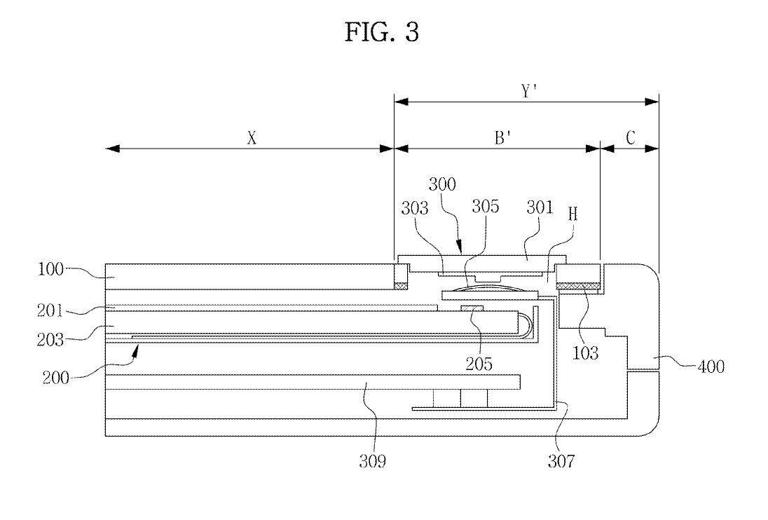

Hereinafter, a mobile communication device according to various embodiments of the present disclosure will be described in detail with reference to FIG. 3 to FIG. 6.

FIG. 3 is a cross-sectional view showing a mobile communication device according to an exemplary embodiment of the present invention.

Referring to FIG. 3, the mobile communication device includes a window unit 100, a display module 200, and a button input unit 300.

The display module 200 includes a display part 201 configured to display an image for the mobile communication device, a driving part 205 configured to drive the display part 201 and a base part 203 on which the display part 201 and the driving part 205 are disposed.

The button input unit 300 is configured to operate or press a switch 305 such that an input signal is transmitted when the switch 305 connects electric nodes if a user presses the button input unit 300. The button input unit 300 includes a button part 301, an input part 303 formed or disposed below the button part 301 and the switch 305 formed to selectively contact the input part 303. Further, the switch 305 and the input part 303 may be disposed in continuous contact such that the switch 305 is selectively operable. Accordingly, if the user selectively presses a button, an input signal may be transmitted when the switch 305 is operated or pressed down.

The window unit (e.g., a window comprising a transparent area) 100 is disposed to cover various parts, such as the display module 200. The window unit 100 may be classified into an active area which is transparent to display an image and an inactive area having an opaque or black printing 103 formed or disposed on one surface of the window unit 100, and various parts may be disposed in the inactive area inside the device.

The term ‘active area’ refers to an area of the window unit 100 where an image is displayed or a touch may be input and recognized, and a user may view a displayed image through the active area or input a touch signal in the active area. The ‘active area’ may be an area including a display area and a touch area on the window unit 100.

The ‘inactive area’ refers to an area other than the ‘active area’ in the window unit 100, e.g., an area surrounding the active area. The ‘inactive area’ may be all areas other than an active area of the window unit 100 where an image is displayed or a touch input is recognized, and the inactive area may include, for example, an adhesion area for attaching the window unit 100, a hard-type button area for receiving an input other than a touch input, an area for ensuring a mechanical tolerance of the active area, or the like.

Further, a through hole H may be formed at one end of the window unit 100, e.g., the lower end of the window unit 100, through which a portion of the button part 301 penetrates or extends. As shown in FIG. 3, the button part 301 of the button input unit 300 is disposed above the driving part 205, so that the button input unit 300 and the driving part 205 are disposed to be vertically overlapped at least in part. For example, the button input unit 300 and the driving part 205 need not completely overlap.

Throughout the specification, the term ‘vertical’ may be a direction perpendicular to the front surface of the window unit 100 (components are disposed along the vertical direction from the bottom housing to the window unit 100 based on the arrangement direction of the window unit 100). Further, the term ‘horizontal’ may be a direction parallel to the front surface of the window unit 100 (components may be arranged side by side along the arrangement direction of the window unit 100, which is parallel to the front surface of the window unit 100). The front surface of the window unit 100 displays an image generated by the display module 200.

Therefore, if the button input unit 300 and the driving part 205 are arranged in a vertical structure, the button input unit 300 and the driving part 205 are arranged along the direction perpendicular to the front surface of the window unit 100 as shown in FIG. 3. If the button input unit 300 and the driving part 205 are arranged in a horizontal structure, the components are arranged along a direction parallel to the front surface of the window unit 100.

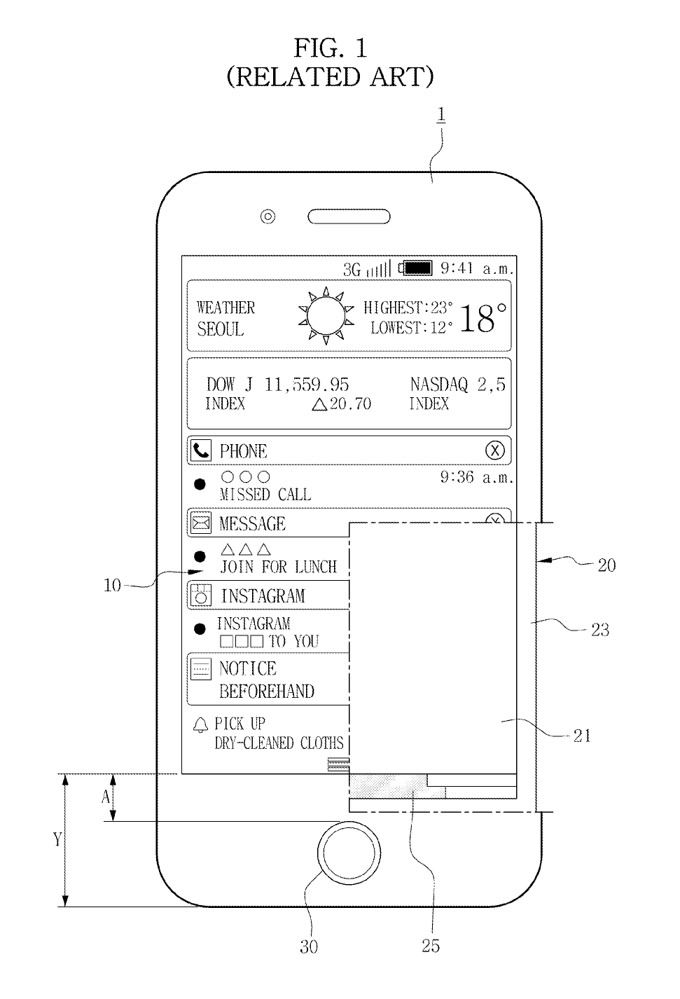

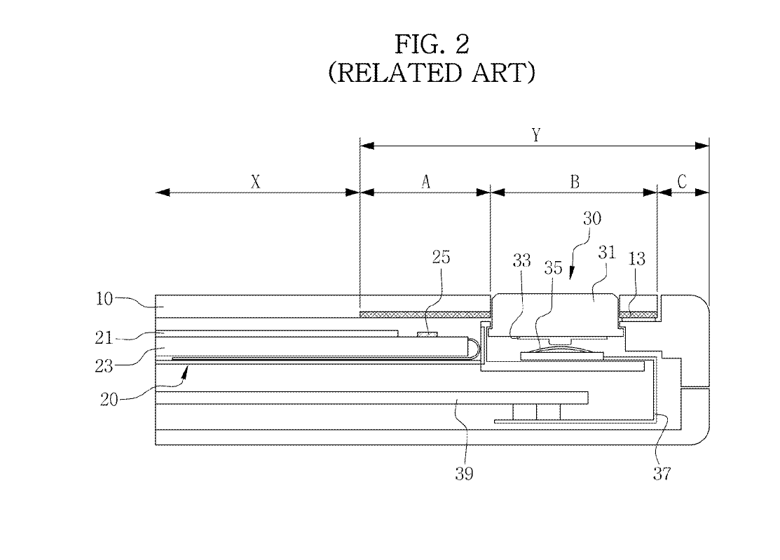

Accordingly, even though the length A (see FIG. 1 and FIG. 2) is configured to accommodate the display module 20, the length A may also accommodate the button input unit 300 such that the distance between the lower edge of the display area having a length X (active area) and the button input unit 300 is reduced or eliminated (See e.g., FIG. 3). As a result, since the length A corresponding to the distance between the display area and the button input unit 300 is excluded or reduced, the entire length of the mobile communication device is shortened, and the distance between the button input unit 300 and the display area decreases, which may enhance user convenience.

Hereinafter, the configuration of the mobile communication device will be described in more detail with reference to FIG. 3.

Referring to FIG. 3, the mobile communication device includes a display module 200, a window unit 100, and a button input unit 300. The display module 200 includes a display part 201, a driving part 205, and a base part 203 on which the display part 201 and the driving part 205 are disposed. The driving part 205 drives the display module 200. In addition, the button input unit 300 is formed at one end of the window unit 100, and a black or opaque printing 103 may be formed at one end of the window unit 100 to hide parts beneath the inactive area in which an image is not displayed. According to aspects, the opaque printing 103 need not be included. The button input unit 300 includes a button part 301, an input part 303, and a switch 305 contacting the input part 303. The input part 303 and the switch 305 are configured to be connected to each other to electrically connect to a main circuit unit 309 through a flexible printed circuit board 307.

More specifically, the display module 200 includes a display part 201, a base part 203, and a driving part 205. The display module 200 may be implemented in various configurations, for example a thin film transistor (TFT), a light emitting diode (LED), an organic light emitting diode (OLED), an active matrix organic light-emitting diode (AMOLED), an on-cell type touch AMOLED (OCTA) or the like, without being limited thereto.

The display part 201 is used for displaying a desired image and may include a polarizing plate, a glass or the like, without being limited thereto. The display part 201 may be larger than a display area in which an image is displayed, in order to display an image of a desired size. The display part 201 may be implemented and operated in various manners as described above.

The base part 203 allows various parts to be loaded or disposed thereon to implement the display module 200. If an LCD is used as the display module, the base part 203 may be composed of a glass and a flexible printed circuit board formed thereon. The configuration and structure of the base part 203 may vary depending on the kind or configuration of a desired display module, and various kinds of display modules available in the art may be applied.

The display part 201 may be a component, which directly outputs images and signals, among components stacked on the base part 203. If an LCD module is used as the display module, the display part 201 may include a glass and a polarizer stacked on a substrate of the base part 203.

The display part 201 and the driving part 205 may be disposed on the base part 203, and the base part 203 may be fixed to an inner housing to support parts disposed on the base part 203.

The driving part 205 may be a semiconductor integrated circuit (IC) for providing a driving signal and data as electric signals to a display panel in order to display a text or image on a screen. Depending on the display module 200, various kinds of integrated circuits may be included therein.

The driving part 205 may be implemented as an integrated circuit selected from various driver ICs, such as a liquid crystal display (LCD) driver IC, a light emitting diode (LED) driver IC, an organic light emitting diode (OLED) driver IC or the like. Further, the driving part 205 may be disposed at one end of the base part 203, or at a lower end of the mobile communication device.

The mobile communication device may include a button input unit 300 and a touch input unit (not shown). Accordingly, a user may input information by using buttons or touching the display area of the mobile communication device.

The button input unit 300 may include a button part 301 for receiving a key input of a user and an input part 303 for pressing a switch, which generates an electric signal when pressed by the input part 303.

In FIG. 3, the button part 301 is illustrated as a single hard-type key, but various kinds and numbers of keys may also be used. Similarly, even though the input part 303 may have a protruding structure at its center, various configurations for transmitting a physical key input of a user to the switch may also be applied. In addition, the input part 303 may be made of various materials, such as rubber, plastic, metal, or the like.

A physical key input of a user input received through the button input unit 300 may be converted into an electric signal by the switch 305. The electric signal may be transmitted to the main circuit unit 309 through the connection unit 307, which connects the switch 305 and the main circuit unit 309. The connection unit 307 and the switch 305 may be implemented on a circuit board, particularly on a flexible printed circuit board.

More specifically, the switch 305 may be disposed in a housing 400 of the mobile communication device at a location corresponding to or beneath the location of the button input unit 300 and/or the input part 303 such that the switch 305 is at least partially disposed between the driving part 205 of the display module 200 and the input part 303 such that the distance between the lower edge of the display area and the button input unit 300 is reduced. Accordingly, if a physical key input generated by pressing the button part 301, the input part 303 presses the switch 305 down so that an electric signal is generated by switching on the switch 305. Further, the input part 303 is configured to selectively press the switch 305 according to a key input of a user. In this case, if there is no physical key input of a user, the input part 303 may not operate the switch 305. If a physical key input of the user is input, the input part 303 may operate the switch 305.

The input part 303 may be formed to operate the switch 305 by selectively pressing the switch 305. However, the input part 303 may also be formed to operate the switch 305 in various ways, without being limited thereto.

For example, the switch 305 may be a dome-type switch. Further, the dome-type switch may provide a ‘clicking’ sound and/or tactile feedback when pressing the button input unit 300.

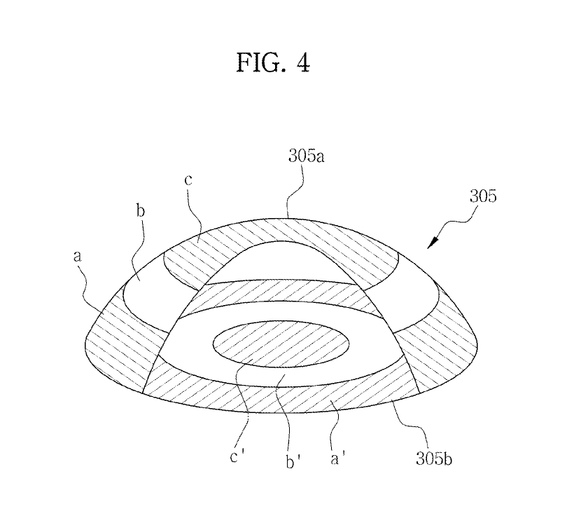

FIG. 4 is a perspective view showing a dome-type switch according to an exemplary embodiment of the present invention. In FIG. 4, a dome-type second electrode part is partially sectioned.

The dome-type switch 305 is electrically connected to a main circuit unit, e.g., the connection unit 307. The dome-type switch 305 includes a first electrode part 305b comprising a first electrode a′, first insulating portion b′ and a second electrode c′ arranged along the radial direction, e.g., from the second electrode c′ located at the center to the first electrode a′ located at the circumference and a dome-type second electrode part 305a comprising a third electrode a, a second insulating portion b, and a fourth electrode c along the circumferential direction as shown in FIG. 4. The first electrode a′ and the third electrode a are attached to each other, and the second electrode c′ and the fourth electrode c selectively contact each other according to an input of the physical key input to generate an electric signal.

Accordingly, when pressing the button part 301, the user may sense a ‘clicking’ tactile feedback and/or may hear a clicking sound and generate and transmit an electric signal to the main circuit unit 309 as the second electrode c′ and the fourth electrode c contact each other.

Referring to FIG. 3, the window unit 100 may be classified into an active area having a length X where a touch of a user is input and a desired image is displayed and an inactive area having a length B′ surrounding the active area.

The outer surface of the window unit 100 may be directly contacted by the user, and the active area (length X) may receive a touch input of the user. The housing 400 of the mobile communication device corresponding to the window unit 100 may contain various components. In FIG. 3, the display module 200 and the button input unit 300 may be disposed in the housing 400. In particular, the display module 200 may be disposed in the housing 400 of the mobile communication device at a portion corresponding to the active area of the window unit 100, and the button input unit 300 may be loaded at a portion corresponding to the inactive area of the window unit 100. The display area of the display module 200 may be disposed at a portion corresponding to the active area of the window unit 100 inside the housing 400.

Since some components disposed in the housing 400 may not be entirely or partially exposed to outside, the inactive area (length B′) of the inner surface may be formed to hide some parts or components disposed in the housing 400 by using the black printing 103. According to aspects, the opaque printing 103 need not be included.

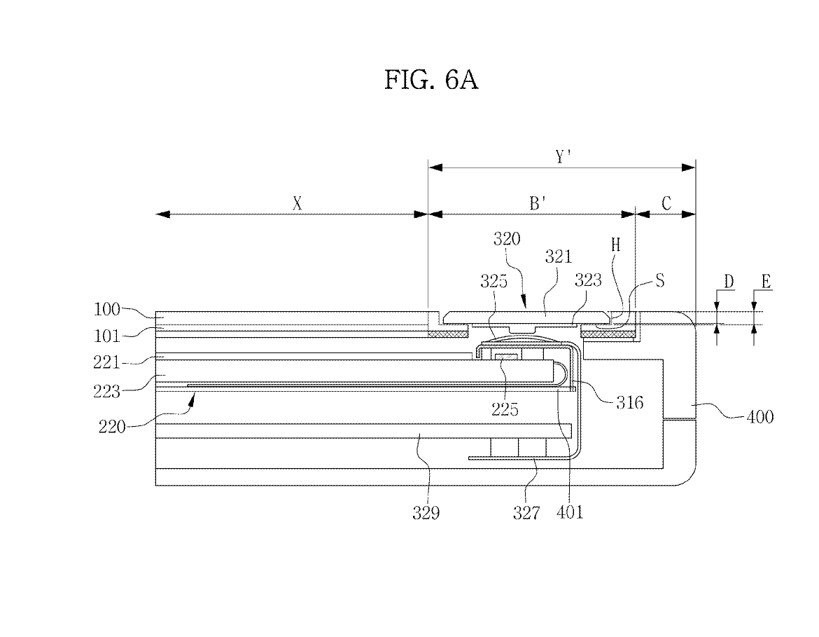

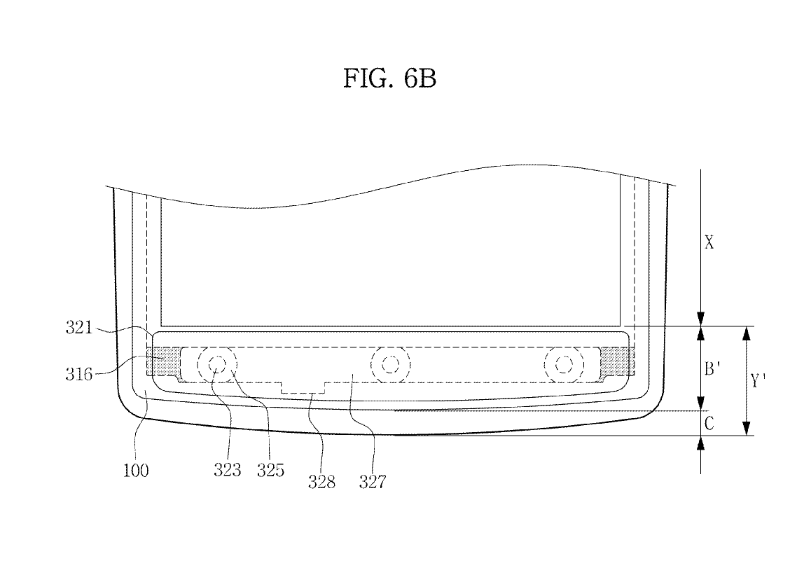

The active area (length X) of the window unit 100 includes a display area and a touch area. Accordingly, the display part 201 of the display module 200 and the touch input unit (not shown) are disposed at portions corresponding to the active area in the mobile communication device. Therefore, the display part 201 of the display module 200 may be disposed inside the mobile communication device at a portion corresponding to the active area (length X) of the window unit 100. Similarly, the touch input unit (not shown) may be disposed inside the mobile communication device at a portion corresponding to the active area (length X) of the window unit 100. Referring to FIG. 6A, the touch input unit may be a layer 101 in the window unit 100. The window unit 100 may be disposed above the display module 200, and one or more layers may be disposed between the window unit 100 and the display module 200. For example, the touch input unit, e.g., a touch sensing layer, may be disposed between the window unit 100 and the display module 200, but aspects are not limited as such. The touch sensing layer may be a transparent layer connected to a flexible printed circuit board, e.g., Indium Tin Oxide (ITO) film, and the like.

For example, the touch input unit may be disposed according to e.g., an add-on type where the touch input unit is loaded on a display module or below a window glass, an on-cell type where the touch input unit is disposed between an upper polarizing plate and an upper glass in the display module, and an in-cell type where the touch input unit is disposed at the center between the upper glass and the lower glass in the display module. However, the configuration of the touch input unit is not limited as such.

The driving part 205 for the display module 200 may be disposed inside the housing 400 of the mobile communication device at a portion corresponding to the inactive area (length B′) of the window unit 100, and the button input unit 300 may be disposed above the driving part 205. The button input unit 300 may be disposed in a through hole H formed in the inactive area (length B′). Accordingly, the driving part 205 and the button input unit 300 are arranged to have a vertical structure, which may decrease a distance between the button input unit 300 and an active area of the window unit 100.

In the structure of FIG. 2, the display module 20 and the button input unit 30 are loaded to have a horizontal structure. Accordingly, the display part 21 is formed inside the mobile communication device at a portion corresponding to the active area (length X), and the driving part 25 of the display module 20 and the button input unit 30 are disposed in parallel inside the mobile communication device at portions corresponding to the inactive area (length A+length B). Specifically, the driving part 25 is disposed at a location corresponding to the inactive area (length A), and the button input unit 30 is disposed at a location corresponding to the inactive area (length B). Accordingly, the width of the inactive area is determined as the sum of the length A where the driving part 25 of the display module 20 is disposed and the length B where the button input unit 30 is disposed. As a result, since the width of a margin area having a length Y of the mobile communication device is determined by the sum of the width of the inactive area and the width C of the housing of the device, the width of the margin area having the length Y is determined by the length A in which the driving part 25 is disposed, the length B in which the button input unit 30 is disposed, and the width C of the housing. Even though the width C of the housing may change variously according to the design elements of the device, the minimal length of the device is determined by at least the length A where the driving part 25 is disposed and the length B where the button input unit 30 is disposed.

However, in the structure of FIG. 3, since the driving part 205 and the button input unit 300 are disposed in the inactive area (length B′) to have a vertical structure, a separate area corresponding to the region having the length A illustrated in FIG. 2 may be eliminated. Therefore, since the inactive area includes only the region having the length B′, the length of the margin area having a length Y′ may also be determined by the length B′ in which the button input unit 300 is disposed and the width C of the housing 400. As a result, the length of the margin area having a length Y′ may be reduced.

Further, according to the structure of FIG. 2, since the length A is present between the display area having the length X and the button input unit 30, buttons are far from the screen, which may cause inconvenience. However, according to the structure of FIG. 3, the length B′ in which the button input unit 300 is disposed directly contacts the display area.

FIG. 3 is a cross-sectional view showing a mobile communication device according to an exemplary embodiment of the present invention. In FIG. 3, a through hole H is formed in the window unit 100 and a button part 301 is formed to pass through the through hole H. More specifically, since the button part 301 may contact the outer surface of the through hole H so that a part of the button part 301 protrudes beyond or over the outer surface and the other part is inserted into the through hole H.

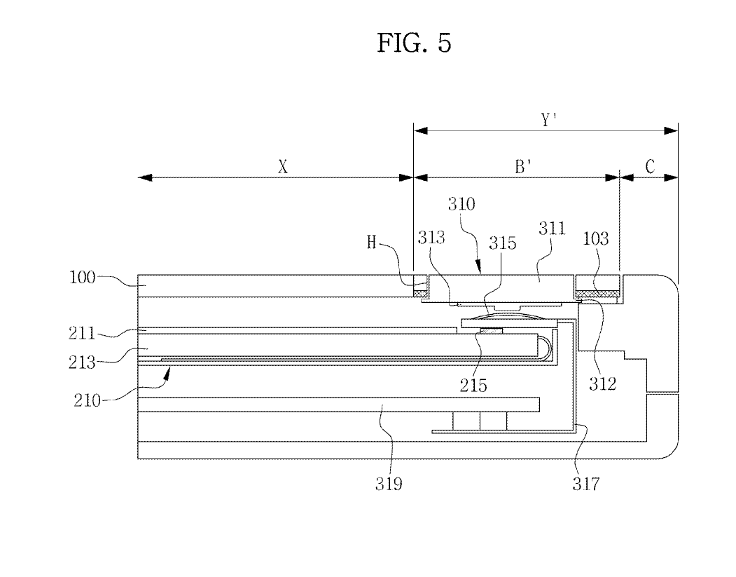

FIG. 5 is a cross-sectional view showing a mobile communication device according to an exemplary embodiment of the present invention.

Referring to FIG. 5, the mobile communication device includes a display module 210, a window unit 100, and a button input unit 310. The display module 210 includes a display part 211, a driving part 215 for the display part 211 and a base part 213 on which the display part 211 and the driving part 215 for the display part 211 are disposed. Further, the button input unit 310 is formed at one end of the window unit 100, and an opaque printing 103 may be formed at an end of the window unit 100 in order to hide parts loaded in the mobile communication device. The button input unit 310 includes a button part 311, an input part 313, and a switch 315 contacting the input part 313 and/or the button part 311. The input part 313 and the switch 315 may be formed to selectively contact each other to electrically connect to a main circuit unit 319 through a connection unit 317. According to aspects, the opaque printing 103 need not be included. The switch 315 may be disposed adjacent to or on the display module 215.

Further, a through hole H is formed in the window unit 100. In FIG. 5, the button part 311 may also be formed to pass through the through hole H. The button part 311 may contact the inner surface of the window unit 100, so that a part of the button part 311 is located inside the through hole H and another part of the button part 311 protrudes downwards toward the display module 210 below the inner surface of the window unit 100.

A flange unit 312 for securing the button part 311 in the inner surface of the window unit 100 may be provided around the bottom of the button part 311. The flange unit 312 having a size greater than the through hole H is formed at the button part 311 so that the flange unit 312 secures the button part 311 in the through hole H.

In the structures of FIG. 5, the button part 301, 311 is secured in the through hole H by e.g., the flange unit 312 at the outer surface or the inner surface of the window unit 100. In the structure of FIG. 3, the button part 301 may be secured in the through hole H by e.g., adhesive, a fixing part, or the like. Therefore, a part of the button part 301, 311 may be securely located inside the through hole H, and the other part may protrude from the outer surface or the inner surface of the window unit 100.

Here, the term ‘inside’ and ‘outside’ represents the inside and the outside of the mobile communication device, respectively. For example, the outer surface of the window unit 100 refers to a surface located at the outside of a device, which may be contacted by a user, and the inner surface of the window unit 100 refers to a surface located at the inside of the device or is disposed to face the display module 200, 210, which may not be contacted by a user without opening the housing.

FIG. 6A and FIG. 6B show a structure of a mobile communication terminal in which the thickness of the mobile communication terminal may be reduced.

FIG. 6A is a cross-sectional view showing a mobile communication device according to an exemplary embodiment of the present invention. Referring to FIG. 6A, a step portion S may be formed at the through hole H. For example, the step portion S, e.g., a groove, may be formed around the circumference of the through hole H at an outside surface of the window unit 100.

Referring to FIG. 6A, the mobile communication device includes a display module 220, a window unit 100, and a button input unit 320. The display module 220 includes a display part 221, a driving part 225 for the display part 221, and a base part 223 on which the display part 221 and the driving part 225 for the display part are disposed. The button input unit 320 is formed at one end of the window unit 100 and includes a button part 321, an input part 323, and a switch 325 contacting the input part 323 and/or the button part 321. The input part 323 and the switch 325 selectively contact each other to electrically connect to a main circuit unit 329 through a connection unit 327 and provide an electric signal indicating an input is received through the button input unit 320. However, aspects are not limited thereto such that the input part 323 and the switch 325 may continuously contact each other to selectively operated the switch 325.

More specifically, the step portion S may be formed at the through hole H toward the outer surface of the window unit 100. In addition, the button part 321 may be loaded on the step portion S. The button part 321 may be fixed to or disposed on the step portion S by attaching an adhesive or an adhesion sheet to an end of the button part 321.

Further, the height E of the step portion S, the distance from the outer surface of the window unit 100 to the step portion S, may be equal to or greater than the height D of the button part 321. Accordingly, even though the button part 321 is loaded or disposed on the step portion S, the button part 321 may be formed not to protrude over or extend beyond the outer surface of the window unit 100. More specifically, with respect to the outer surface of the window unit 100, the upper surface of the button part 321, which a user's finger may touch, is located to correspond to or may be at a same level as the outer surface of the window unit 100 as shown in FIG. 6 or disposed below the outer surface of the window unit 100 such that the surface of the button part 321 may form a recess or an indentation. Accordingly, it is possible to prevent the button part 321 from protruding over the outer surface or inner surface of the window unit 100 and thus increasing the thickness of a product. As a result, the thickness as well as the entire length of the device is reduced, and the entire size of the mobile communication device may be effectively reduced.

Further, a support structure (supporter) 316 for supporting the switch 325 may be further provided. In order to prevent the driving part 225 formed below the switch 325 from physically contacting the switch 325 and possible damage to the driving part 225, a support structure 316 to maintain an interval between the switch 325 and the driving part 225 may be further provided.

Referring to FIG. 6A, the support structure 316 may have a bracket shape fixed on the housing 400, particularly an inner housing 401, which fixes and supports the display module 220. In addition, the support structure 316 may be made of various materials, such as stainless steel, for example.

Accordingly, the button input unit 320 may be disposed on a location above the display module 220 without giving an influence to the display module 220, while stably fixing the switch 325 to the housing 400, i.e., the inner housing 401. The inner housing may support the display module 220 and the supporting unit 316, but aspects are not limited as such. The display module 220 and the supporting unit 316 may be supported by the housing 400 and/or other components.

FIG. 6B is a transparent view of the mobile communication device of FIG. 6A according to an exemplary embodiment of the present invention. While FIG. 6A shows a cross-sectional view of a mobile communication device when viewed from a direction perpendicular to a side surface of the mobile communication device, FIG. 6B shows a plan view of the mobile communication device when viewed from a direction perpendicular to the front surface of the mobile communication device.

Referring to FIG. 6B, the window unit 100 of the mobile communication device includes an active area having a length X in which an image is displayed and an inactive area having a length B′.

In the active area (length X), a touch input may be recognized and an image may be displayed.

A driving part for operating the display module may be located in the inactive area (length B′), and a support structure 316 may be located above the driving part. The support structure 316 may be connected to the inner housing 401 shown in FIG. 6A. A connection unit 327 having the switch 325 may be disposed on the support structure 316. The connection unit 327 may be a flexible printed circuit board, and the flexible printed circuit board may extend to connect through a bent connection unit 328 to the main circuit unit 329 formed at the rear surface of the device.

The switch 325 may be formed to have a rounded dome-type switch structure, and the input part 323 (in FIG. 6B, only a protruding structure of the input part 323, a portion contacting the switch 325, is depicted) may be disposed above the switch 325. The input part 323 may be formed to selectively contact the switch 325 according to an input of the user pressing the button part 321. The input part 323 may be formed at a bottom of the button part 321.

In FIG. 6B, the button part 321 is illustrated as a single button surrounding three input parts, but aspects are not limited thereto. In another example, a plurality of button parts may be formed separately for the input parts, respectively. For example, three button parts may also be provided to surround three input parts, respectively.

Referring to FIG. 6B, the distance between the active area (length X) where an image is displayed and the button part 321 may be reduced in comparison with the structure illustrated in FIG. 2. Further, the length of the margin area having a length Y′ configuring at least a portion of the rim of the device is determined by the length B′ corresponding to the inactive area and the width C of the housing.

As a result, the entire length of the mobile communication device, particularly the length of a lower end portion of the device, may be reduced. Accordingly, the size of the active area (length X) may be enlarged for mobile communication devices having the same size and the size of the inactive area is reduced so that the entire length of the margin area having the length Y′ is reduced.

Further, the size of a margin area may be decreased while ensuring a large display area of a mobile communication device. Accordingly, the mobile communication device may have a large screen while maintaining a small product size.

In addition, in the mobile communication device, the distance between the button input unit and the display area may be shortened. Accordingly, a user may use buttons while watching a screen, thereby ensuring enhanced convenience.

Moreover, while the mobile communication device includes both the button input unit and an enlarged touch screen display, the entire length of the mobile communication device may be reduced, and the thickness of the device may also be reduced.

It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A mobile device, comprising:
a window to receive a touch input of a user;
a housing on which the window is mounted; and
a display module comprising a display part configured to display an image through the window and a driving part configured to drive the display part,
wherein the window is disposed above the display module and the physical key is disposed above the driving part.

2. The mobile device of claim 1, wherein the window comprises a step portion disposed at a circumference of the through hole, the step portion being disposed at a side of the window facing away from the display module.

3. The mobile device of claim 2, wherein a button part of the physical key is disposed on the step portion, the button part being configured to be exposed to the outside.

4. The mobile device of claim 1, further comprising a switch configured to be operable by the physical key, the switch being disposed on a supporter disposed between the driving part and the physical key.

5. The mobile device of claim 4, wherein the switch is a dome switch and connected to a flexible printed circuit board to transmit an electrical signal indicating that the physical key is pressed.

6. The mobile device of claim 4, further comprising an inner housing connected to the housing,
wherein the inner housing supports the display module and the supporter.

7. The mobile device of claim 1, further comprising a base part on which the display part and the driving part are mounted.

8. The mobile device of claim 1, further comprising a touch input unit disposed between the window and the display module.

9. The mobile device of claim 1, wherein the window comprises a surface facing the display module on which an opaque printing is disposed around the through hole.

10. The mobile device of claim 1, further comprising a supporter on which a switch is disposed, the switch being disposed between the driving part and the physical key and being configured to be operated when the physical key is pressed.

11. The mobile device of claim 1, wherein the window comprises a through hole to accommodate a physical key.

12. A mobile device, comprising:
a window to receive a touch input of a user, the window comprising an active area and an inactive area;
a housing on which the window is mounted; and
a display module comprising a display part configured to display an image through the active area of the window and a driving part configured to drive the display part,
wherein the window is disposed above the display module and at least part of the physical key is disposed above the driving part.

13. The mobile device of claim 12, wherein the window comprises a step portion disposed at a circumference of the through hole in the inactive area, the step portion being disposed at a side of the window facing away from the display module.

14. The mobile device of claim 13, wherein a button part of the physical key is disposed on the step portion, the button part being configured to be exposed to the outside.

15. The mobile device of claim 12, further comprising a switch configured to be operable by the physical key, the switch being disposed on a supporter disposed between the driving part and the physical key.

16. The mobile device of claim 15, wherein the switch is a dome switch and connected to a flexible printed circuit board to transmit an electrical signal indicating that the physical key is pressed.

17. The mobile device of claim 15, further comprising an inner housing connected to the housing,
wherein the inner housing supports the display module and the supporter.

18. The mobile device of claim 12, further comprising a base part on which the display part and the driving part are mounted.

19. The mobile device of claim 12, further comprising a touch input unit disposed between the window and the display module, the touch input unit corresponding to the active area.

20. The mobile device of claim 12, wherein the window comprises a surface facing the display module on which an opaque printing is disposed in the inactive area.

21. The mobile device of claim 12, further comprising a supporter on which a switch is disposed, the switch being disposed between the driving part and the physical key and being configured to be operated when the physical key is pressed.

22. The mobile device of claim 12, wherein the inactive area comprises a through hole to accommodate a physical key.
